(19) United States
(12) Patent Application Publication
(10) Pub. No.: US 2005/0058281 A1
(43) Pub. Date: Mar. 17, 2005

(54) Blue tooth ear piece having termometer

(76) Inventor: Chia Chun Tung, Hsin Chuang City (TW)

Correspondence Address: Chia Chun TUNG, P.O. Box 4-67, Hisn Chuang, Taipei, 242, TW

(21) Appl. No.: 10/662,650

(22) Filed: Sep. 12, 2003

(51) Int. Cl. H04M 1/00; H04M 9/00

(52) U.S. Cl. 379/431

(57) ABSTRACT

A blue tooth ear piece includes a receiver device for attaching onto ears of users, and a talking device for talking phones. A circuit board includes a speaker and a microphone attached to the receiver device and the talking device. A temperature detector is attached to the receiver device for detecting body temperature of the users. The circuit board includes a temperature detecting circuit coupled between a CPU and the temperature detector, and a key coupled to the temperature detecting circuit to selectively operate the temperature detecting circuit to actuate the temperature detector to detect the body temperature of the users.

### BACKGROUND OF THE INVENTION

1. Field of the Invention

The present invention relates to an ear piece, and more particularly to a blue tooth ear piece having a thermometer or a temperature detecting device for detecting the body temperatures of the users.

2. Description of the Prior Art

Typical ear pieces are provided for receiving and/or for talking phones, and comprise a structure for attaching onto the ear portions of the users. The typical ear pieces do not have any temperature detecting device for detecting the body temperatures of the users.

For some of the patients that are required to be carefully taken care of, the nurses or the doctors may have to go to see the patients frequently, and to check the body temperatures of the patients frequently.

The present invention has arisen to mitigate and/or obviate the afore-described disadvantages of the conventional ear pieces.

### SUMMARY OF THE INVENTION

The primary objective of the present invention is to provide a blue tooth ear piece including a temperature detecting device for detecting the body temperatures of the users or patients in far away distance.

In accordance with one aspect of the invention, there is provided a blue tooth ear piece comprising a receiver device for attaching onto ears of users, and a talking device for talking phones, a circuit board including a speaker coupled thereto and attached to the receiver device for receiving the phones, a microphone coupled to the circuit board and attached to the talking device for talking the phones, and a temperature detector attached to the receiver device for detecting body temperature of the users.

The circuit board includes a CPU, a blue tooth circuit coupled to the CPU, and an antenna coupled to the blue tooth circuit for telecommunicating purposes. The circuit board includes a modulator coupled between the CPU and the speaker and the microphone respectively.

The circuit board includes a temperature detecting circuit coupled between the CPU and the temperature detector for actuating the temperature detector to detect the body temperature of the users.

The circuit board includes a key coupled to the temperature detecting circuit to selectively operate the temperature detecting circuit to actuate the temperature detector to detect the body temperature of the users. A blue tooth receiver may further be provided to receive the body temperature of the users from the blue tooth ear piece.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view illustrating the attachment and the operation of a blue tooth ear piece in accordance with the present invention;

FIG. 2 is a block diagram illustrating the elements or parts of the blue tooth ear piece; and

FIG. 3 is a flow chart illustrating the operation of the blue tooth ear piece.

### DETAILED DESCRIPTION OF THE PREFERRED EMBODIMENT

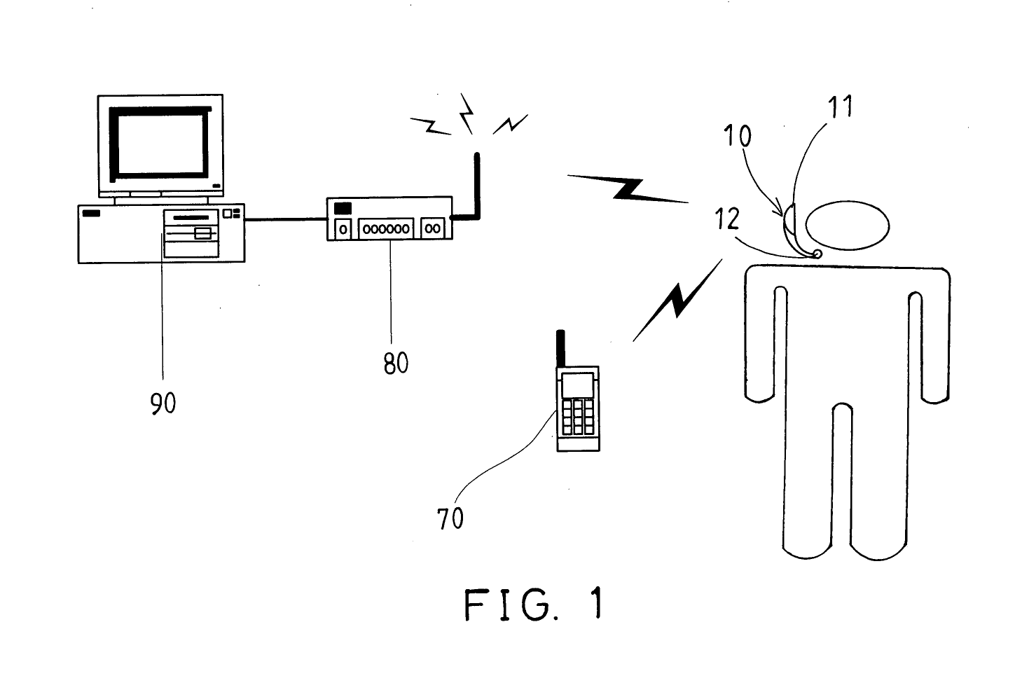

Referring to the drawings, and initially to FIG. 1, a blue tooth ear piece 10 in accordance with the present invention comprises a receiver device 11 for attaching onto the ears of the users or patients or the like, and a talking device 12 for talking the phones.

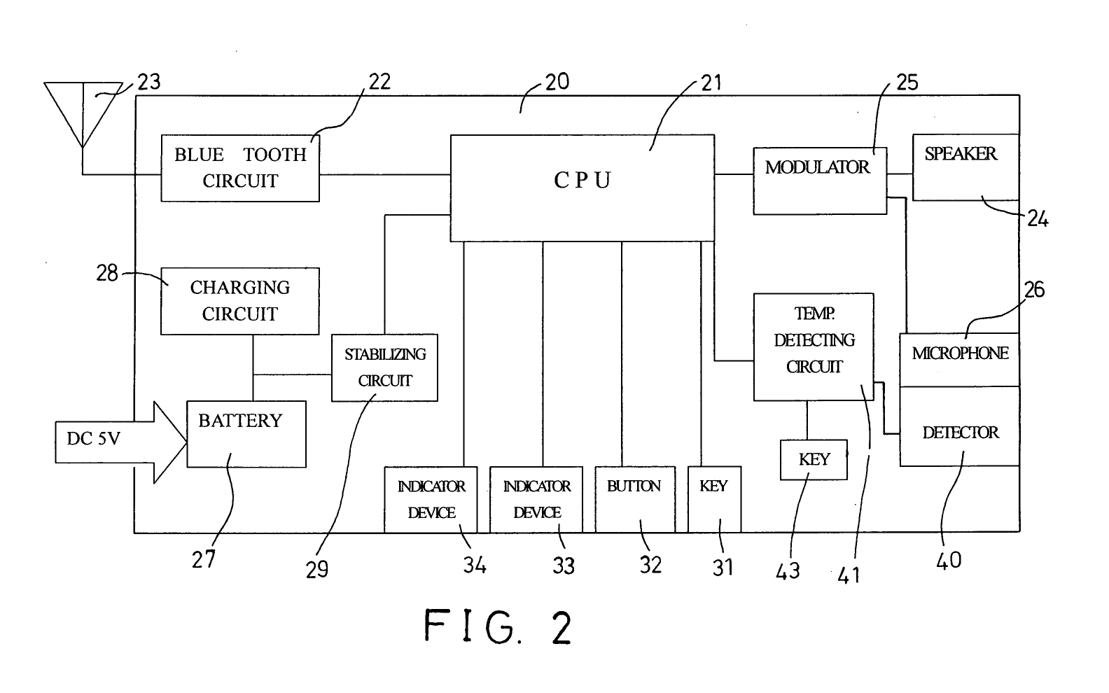

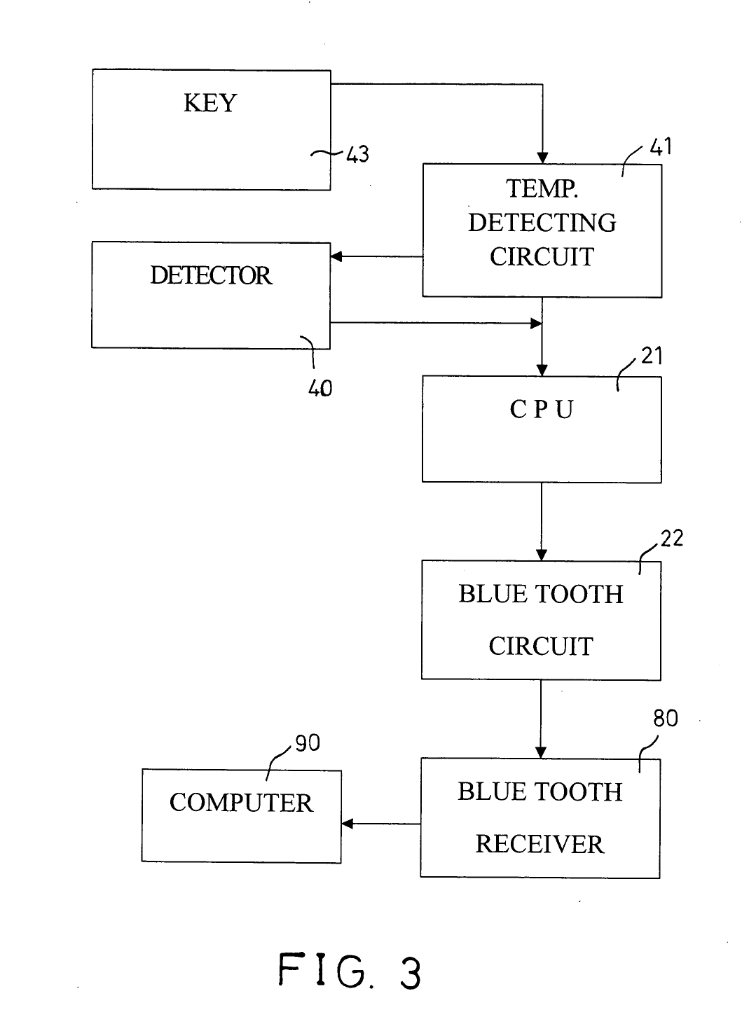

Referring next to FIG. 2, the blue tooth ear piece 10 includes a circuit board 20 disposed therein, such as disposed in the body of the ear piece 10 or the receiver device 11 of the ear piece 10. The circuit board 20 includes a central processing unit (CPU) 21 attached thereto for data or information or signal processing purposes, a blue tooth transmission circuit 22 coupled to the CPU 21 and coupled to an antenna 23 for telecommunicating with portable or mobile phones 70 (FIG. 1), and/or with computers of end users 90 via blue tooth receiver devices 80 (FIGS. 1, 3).

The blue tooth ear piece 10 includes a speaker 24 coupled to the CPU 21 via a modulator 25 or the like, for receiving the phones, and a microphone 26 coupled to the CPU 21 via the modulator 25 or the like, for speaking the phones. The speaker 24 and the microphone 26 are typically attached to the receiver device 11 and the talking device 12 of the blue tooth ear piece 10 respectively.

The blue tooth ear piece 10 includes one or more batteries 27, such as the chargeable batteries 27 coupled to the CPU 21 via a charging circuit 28 and/or a stabilizing circuit 29, for providing stabilized electric power or energy to energize the CPU 21, and the other electric parts or elements. One or more keys 31 are further provided and coupled to the CPU 21 for adjusting the volume of the speaker 24 and/or the microphone 26, for example.

One or more buttons 32 may further be provided and coupled to the CPU 21 for such as receiving the incoming phones. One or more indicator devices 33, 34 may further be provided and coupled to the CPU 21 for indicating the working of the ear piece 10, and/or for indicating the communicating status of the ear piece 10. The above-described structure of the blue tooth ear piece is typical and will not be described in further details.

The blue tooth ear piece 10 further includes a thermometer or a body temperature detector 40, such as an infrared detector 40 coupled to the CPU 21 via a body temperature detecting circuit 41. The body temperature detector 40 may be attached to the receiver device 11 of the blue tooth ear piece 10, for engaging onto or into the ears of the users or of the patients, and for detecting the body temperatures of the users or of the patients.

The body temperature detecting circuit 41 may be used to receive, and to record, and to transmit, and to control the body temperatures of the users or of the patients detected by the body temperature detector 40, and/or to control or to actuate the body temperature detector 40.

A key 43 may further be provided and coupled to the body temperature detecting circuit 41, to selectively actuate the body temperature detecting circuit 41 to control or to actuate the body temperature detector 40, and to detect and obtain the body temperatures of the users or of the patients, when required.

In operation, as shown in FIG. 3, when the key 43 is depressed or actuated by the users or the patients, the body temperature detecting circuit 41 may be operated to actuate the body temperature detector 40 and to detect and obtain the body temperatures of the users or of the patients. The data or information or signals of the body temperatures of the users or of the patients may then be sent to the CPU 21, and then to the computers of end users 90 via the blue tooth receiver devices 80.

It is to be noted that the ear pieces 10 may be easily and continuously attached to the ears of the users or the patients, and may be readily used to detect and obtain the body temperatures of the users or of the patients. The controllers or the nurses or the doctors may easily obtain the body temperatures of the users or of the patients from the computer 90 in distance far away from the users or patients.

Accordingly, the ear piece in accordance with the present invention includes a temperature detecting device for detecting the body temperatures of the users or patients in far away distance.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A blue tooth ear piece comprising:
a receiver device for attaching onto ears of users, and a talking device for talking phones,
a circuit board including a speaker coupled thereto and attached to said receiver device for receiving the phones,
a microphone coupled to said circuit board and attached to said talking device for talking the phones, and
a temperature detector attached to said receiver device for detecting body temperature of the users.

2. The blue tooth ear piece as claimed in claim 1, wherein said circuit board includes a CPU, a blue tooth circuit coupled to said CPU, and an antenna coupled to said blue tooth circuit for telecommunicating purposes.

3. The blue tooth ear piece as claimed in claim 2, wherein said circuit board includes a modulator coupled between said CPU and said speaker and said microphone respectively.

4. The blue tooth ear piece as claimed in claim 2, wherein said circuit board includes a temperature detecting circuit coupled between said CPU and said temperature detector for actuating said temperature detector to detect the body temperature of the users.

5. The blue tooth ear piece as claimed in claim 4, wherein said circuit board includes a key coupled to said temperature detecting circuit to selectively operate said temperature detecting circuit to actuate said temperature detector to detect the body temperature.

6. The blue tooth ear piece as claimed in claim 1 further comprising a blue tooth receiver to receive the body temperature of the users from said blue tooth ear piece.
